(19) United States
(12) Patent Application Publication
(10) Pub. No.: US 2013/0286283 A1
(43) Pub. Date: Oct. 31, 2013

(54) VOICE COIL MOTOR AND CAMERA MODULE USING THE VOICE COIL MOTOR

(71) Applicant: TZU-NAN CHOU, Tu-Cheng (TW)

(72) Inventor: TZU-NAN CHOU, Tu-Cheng (TW)

(21) Appl. No.: 13/654,606

(22) Filed: Oct. 18, 2012

(30) Foreign Application Priority Data
Apr. 27, 2012 (TW) 101115056

(51) Int. Cl. H04N 5/225; H02K 41/03

(52) U.S. Cl. 348/374; 310/12.16; 348/E05.025

(57) ABSTRACT

A voice coil motor includes a fixing assembly and a moveable assembly. The fixing assembly includes a fixing frame and at least one magnet positioned on the fixing frame. The moveable assembly is movably received in the fixing assembly. The moveable assembly includes a moveable barrel. The moveable barrel includes a coil and resin filled in gaps of the coil. When the coil is powered on, the moveable barrel is capable of moving along an axis direction of the moveable barrel by a magnetic force generated by the at least one magnet.

### BACKGROUND

1. Technical Field

The present disclosure generally relates to a voice coil motor and a camera module using the voice coil motor.

2. Description of the Related Art

A voice coil motor is suitable for zooming or focusing a lens module. The voice coil motor includes a fixing assembly, a moveable assembly movably received in the fixing assembly. Magnets are mounted on the fixing assembly. The moveable assembly includes a moveable barrel and a coil wound around the moveable barrel. When the coil is powered on, an electromagnetic force is generated to drive the moveable assembly to move.

The coil is wound around the moveable barrel, thus, additional space for receiving the coil is needed, which increases the volume of the voice coil motor.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric, assembled view of a voice coil motor, according to a first embodiment.

FIG. 2 is an exploded view of the voice coil motor of FIG. 1.

FIG. 3 is a cross-sectional view taken long III-III line of FIG. 1.

FIG. 4 is an isometric, exploded view of a voice coil motor, according to a second embodiment.

FIG. 5 is a cross-sectional view of a camera module according to a third embodiment.

### DETAILED DESCRIPTION

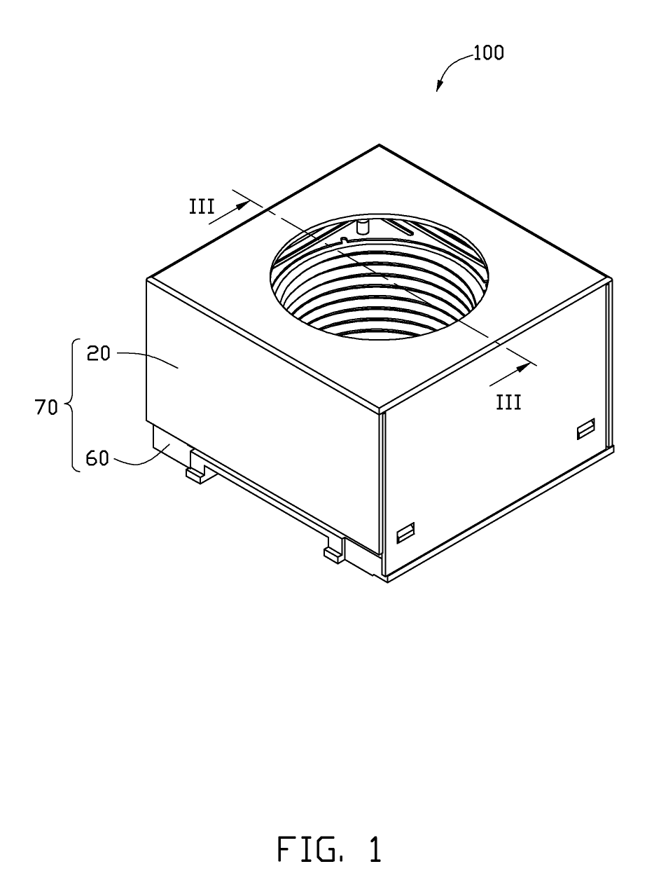

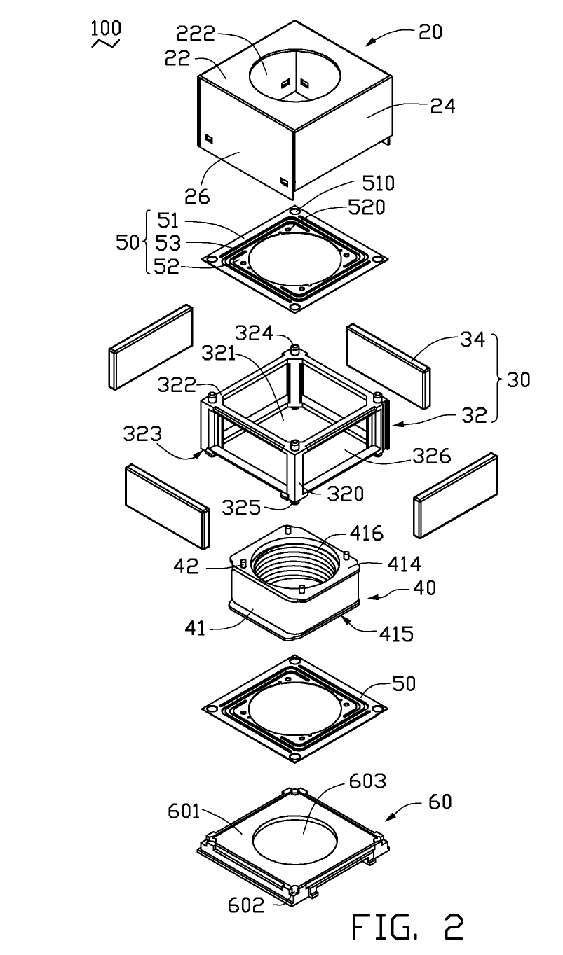

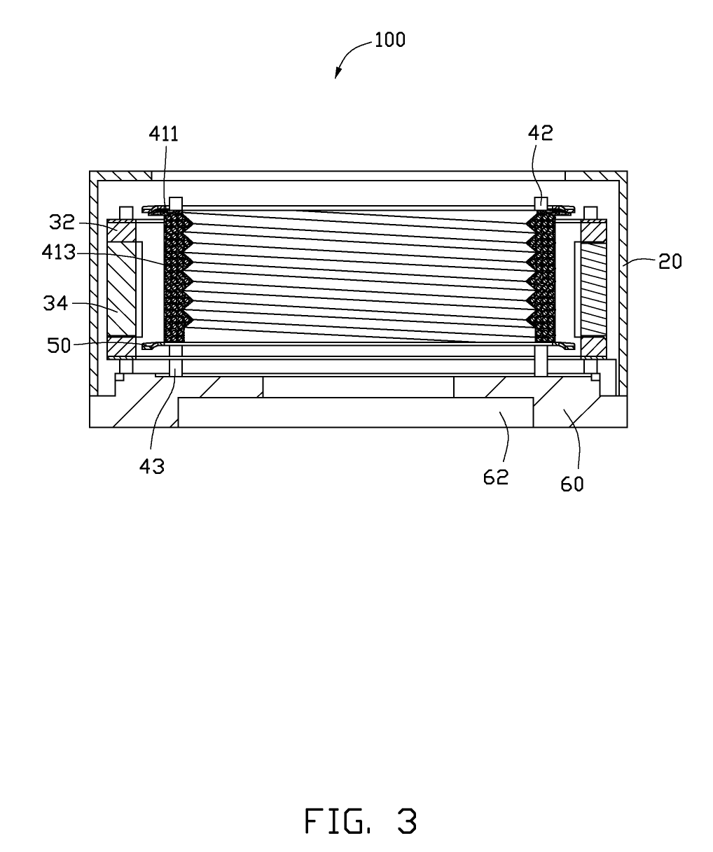

Referring to FIGS. 1-3, a first embodiment of a voice coil motor 100 is shown. The voice coil motor 100 includes a housing 20, a fixing assembly 30, a moveable assembly 40, two elastic sheets 50, and a supporting base 60.

The housing 20 includes a rectangular base plate 22, two first side plates 24 perpendicularly extending from two opposite sides of the base plate 22, and two second side plates 26 perpendicularly extend from the other two opposite sides of the base plate 22. The base plate 22, the first side plates 24, and the second side plates 26 cooperatively form a receiving space for receiving the fixing assembly 30. The base plate 22 defines a first through hole 222 for transmitting light.

The fixing assembly 30 includes a fixing frame 32 and a magnetic unit. In this embodiment, the magnetic unit includes four magnets 34 fixed in the fixing frame 32. The fixing frame 32 is substantially cuboid, and includes four sidewalls 320. The four sidewalls 320 define four receiving holes 326, respectively. The magnets 34 are received in the receiving holes 326 and adhered to the sidewalls 320 with glue. The four sidewalls 320 cooperatively form a receiving space 321 for receiving the moveable assembly 40. The fixing frame 32 further includes a rectangular top surface 322, a rectangular bottom surface 323, four first positioning rods 324 protruding from the top surface 322, and four second positioning rods 325 protruding from the bottom surface 323. The four first positioning rods 324 are positioned at four corners of the top surface 322. The four second positioning rods 325 are positioned at four corners of the bottom surface 323. The first positioning rods 324 and the second positioning rods 325 are used for positioning the two elastic sheets 50.

The moveable assembly 40 includes a moveable barrel 41, four third positioning rods 42 and four fourth positioning rods 43. The moveable barrel 41 includes a coil 411 and resin 413 filled in gaps of the coil 411. In this embodiment, the resin 413 is further adhered to an outer surface of the coil 411. The moveable barrel 41 is substantially cuboid, and includes a rectangular upper surface 414 and a rectangular lower surface 415. The moveable barrel 41 defines a substantially cylindrical second through hole 416 extending from the upper surface 414 to the lower surface 415. The coil 411 surrounds a central axis of the second through hole 416. The second through hole 416 is configured for receiving a lens barrel (not shown).

The four third positioning rods 42 are adhered to four corners of the upper surface 414. The four fourth positioning rods 43 are adhered to four corners of the lower surface 415. The third positioning rods 42 and the fourth positioning rods 43 are used for fixing the moveable assembly 40 to the two elastic sheets 50.

Each of the sheets 50 includes an outer ring 51, an inner ring 52 and connecting arms 53. The connecting arms 53 connect the outer ring 51 to the inner ring 52. The outer ring 51 defines four outer positioning holes 510. The inner ring 52 defines four inner positioning holes 520.

The four outer positioning holes 510 of one elastic sheet 50 spatially correspond to the four first positioning rods 324, respectively. The four outer positioning holes 510 of the other elastic sheet 50 spatially correspond to the four second positioning rods 325, respectively. The first positioning rods 324 and the second positioning rods 325 extend through the corresponding outer positioning holes 510. The first positioning rods 324 and the second positioning rods 325 are adhered to the respective elastic sheets 50 with glue. In this way, the outer rings 51 of the elastic sheets 50 are fastened on the fixing frame 32. The four inner positioning holes 520 of one elastic sheet 50 spatially correspond to the four third positioning rods 42, respectively. The four inner positioning holes 520 of the other elastic sheet 50 spatially correspond to the four fourth positioning rods 43, respectively. The third positioning rods 42 and the fourth positioning rods 43 extend through the corresponding inner positioning holes 520 and are adhered to the elastic sheets 50 with glue. In this way, the inner rings 52 of the elastic sheets 50 are fastened on the moveable barrel 41.

When a force is applied to the inner rings 52, the inner rings 52 drive the moveable assembly 40 to move relative to the fixing assembly 30, and the connecting arms 53 deform correspondingly.

The supporting base 60 is substantially rectangular. The supporting base 60 and the housing 20 cooperatively form a box 70 for receiving the fixing assembly 30, the moveable assembly 40, and the elastic sheets 50.

The supporting base 60 includes a supporting surface 601. The supporting surface 601 defines a third through hole 603. The supporting base 60 further defines four positioning grooves 602 spatially corresponding to the four second positioning rods 325 of the fixing frame 32. The second positioning rods 325 are plugged into the respective positioning grooves 602 to connect the supporting base 60 to the fixing frame 32.

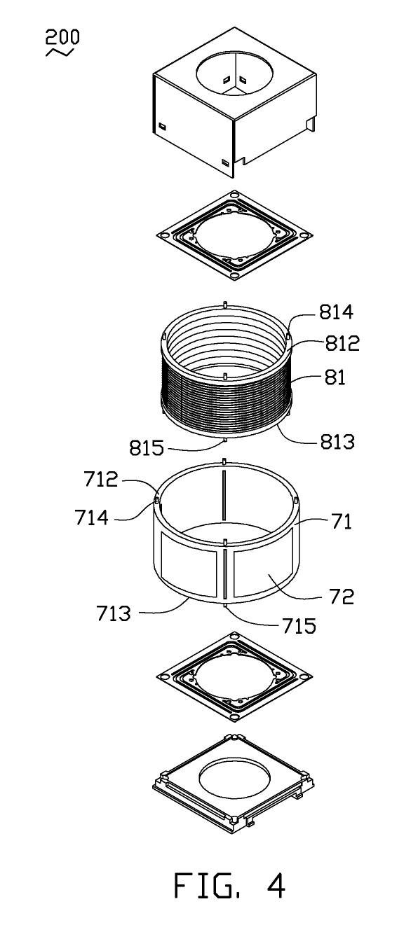

Referring to FIG. 4, a voice coil motor 200 according to a second embodiment is shown. The voice coil motor 200 is similar to the voice coil motor 100, except that a fixing frame 71 and a moveable barrel 81 are cylindrical shaped, and magnets 72 mounted on the fixing frame 71 are arc-shaped. The cylindrical shaped fixing frame 71 includes four first positioning rods 714 on its upper surface 712 and four second positioning rods 715 on its lower surface 713. The cylindrical shaped moveable barrel 81 includes four third positioning rods 814 on its top surface 812 and four fourth positioning rods 815 on its bottom surface 813.

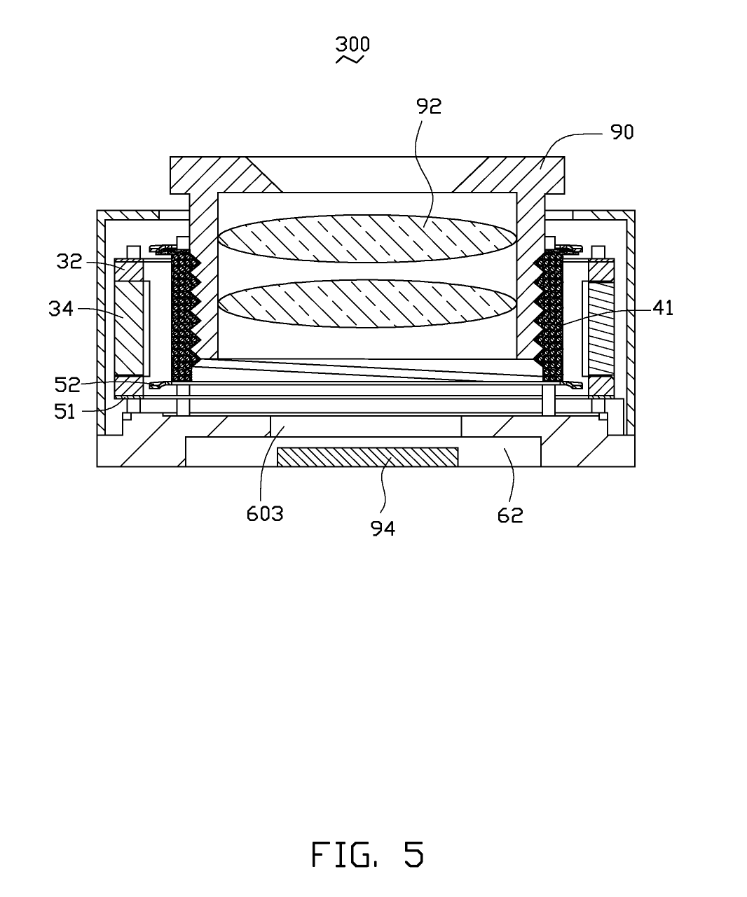

Referring to FIG. 5, a camera module 300 according to a third embodiment is shown. The camera module 300 includes the voice coil motor 100, a lens barrel 90, a number of lenses 92, and an image sensor 94. The lens barrel 90 is received and is fastened in the moveable barrel 41. The lenses 92 are received in the lens barrel 90 to cooperatively form a lens module. The supporting base 60 defines a receiving groove 62 on a surface far away from the elastic sheets 50. The image sensor 94 is received in the receiving groove 62 and is aligned with the third through hole 603. Light passes through the lenses 92, the third through hole 603, and is finally focused on the image sensor 94.

The magnets 34 generate a magnetic field. When the coil 411 of the moveable barrel 41 is powered on, the magnetic field produces an electromagnetic force. The electromagnetic force drives the moveable barrel 41, the lens barrel 90, and the lenses 92 to move along an axis direction of the moveable barrel 41 relative to the fixing frame 32, and the movement of the moveable barrel 41 drives the elastic sheets 50 to deform accordingly. When the coil 411 is powered off, the electromagnetic force is gone, the elastic sheets 50 recover and drive the moveable barrel 41, the lens barrel 90, and the lenses 92 to move back.

As the moveable barrel includes a coil, thus, there is no need to wind a coil around a moveable barrel. In this way, the structure of the voice coil motor is simplified and the volume of the voice coil motor is reduced.

While the present disclosure has been described with reference to particular embodiments, the description is illustrative of the disclosure and is not to be construed as limiting the disclosure. Therefore, various modifications can be made to the embodiments by those of ordinary skill in the art, without departing from the true spirit and scope of the disclosure, as defined by the appended claims.

What is claimed is:

1. A voice coil motor, comprising:
a fixing assembly comprising a fixing frame and at least one magnet positioned on the fixing frame; and
a moveable assembly movably received in the fixing assembly, the moveable assembly comprising a moveable barrel, the moveable barrel comprising a coil and resin filled in gaps of the coil;
wherein when the coil is powered on, the moveable barrel is capable of moving along an axis direction of the moveable barrel by a magnetic force generated by the at least one magnet.

2. The voice coil motor of claim 1, wherein the resin is further adhered to an outer surface of the coil.

3. The voice coil motor of claim 1, further comprising at least one elastic sheet, each of the at least one elastic sheet comprising an outer ring fastened on the fixing frame, an inner ring fastened on the moveable barrel, and connecting arms connecting the outer ring to the inner ring.

4. The voice coil motor of claim 1, wherein the moveable barrel is substantially cuboid.

5. The voice coil motor of claim 1, wherein the moveable barrel is substantially cylindrical shaped.

6. The voice coil motor of claim 1, further comprising a housing and a supporting base, the housing and the supporting base cooperatively forming a box, the box receiving the fixing assembly and the moveable assembly.

7. A camera module, comprising:
a fixing assembly comprising a fixing frame and at least one magnet positioned on the fixing frame; and
a moveable assembly movably received in the fixing assembly, the moveable assembly comprising a moveable barrel, the moveable barrel comprising a coil and resin filled in gaps of the coil;
a lens barrel fixed in the moveable barrel;
at least one lens received in the lens barrel; and
an image sensor optically coupled with the at lease one lens.

8. The camera module of claim 7, wherein the resin is further adhered to an outer surface of the coil.

9. The camera module of claim 7, further comprising at least one elastic sheet, the at least one elastic sheet comprising an outer ring fastened on the fixing frame, an inner ring fastened on the moveable barrel, and connecting arms connecting the outer ring to the inner ring.

10. The camera module of claim 7, wherein the moveable barrel is substantially cuboid.

11. The camera module of claim 7, wherein the moveable barrel is substantially cylindrical shaped.

12. The camera module of claim 7, further comprising a housing and a supporting base, the housing and the supporting base cooperatively form a box, the box receiving the fixing assembly and the moveable assembly therein.

13. A voice coil motor, comprising:
a fixing assembly comprising a fixing frame and at least one magnet positioned on the fixing frame; and
a moveable assembly movably received in the fixing assembly, the moveable assembly comprising a moveable barrel, the moveable barrel consisting of a coil and resin filled in gaps of the coil;
wherein when the coil is powered on, the moveable barrel is capable of moving along an axis direction of the moveable barrel by a magnetic force generated by the at least one magnet.
